(19) United States
(12) Patent Application Publication
(10) Pub. No.: US 2026/0113399 A1
(43) Pub. Date: Apr. 23, 2026

(54) Contextual Retrieval Of Prior Audio Messages In Push-To-Talk Channels

(71) Applicant: Zoom Communications, Inc., San Jose, CA (US)

(72) Inventor: Vi Dinh Chau, Seattle, WA (US)

(21) Appl. No.: 18/924,433

(22) Filed: Oct. 23, 2024

(51) Int. Cl. H04M 1/72436; G10L 15/26; H04W 4/10

(52) U.S. Cl. CPC H04M 1/72436; H04W 4/10; G10L 15/26; H04M 2201/40

(57) ABSTRACT

A device is joined to a push-to-talk (PTT) channel. Prior audio messages transmitted within the PTT channel before the device joined the PTT channel and that are contextually relevant to an ongoing conversation within the PTT channel are identified. The prior audio messages to the device are provided to the device according to a context format.

### FIELD

This disclosure generally relates to push-to-talk (PPT) systems, and, more specifically, to providing context to a client device joining a PTT channel.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 illustrates a high-level, logical architecture of a PTT system designed for identifying contexts for audio messages.

FIG. 5A illustrates a peer-to-peer (P2P) configuration of a PTT system.

FIG. 5B illustrates a server-based configuration of a PTT system.

FIG. 6 is a block diagram of a topic identification tool.

FIG. 7 is a flow diagram for generating context in a server-based PTT system.

FIG. 8 is a flow diagram for generating context in a P2P PTT system.

FIG. 9 illustrates user interfaces of a PTT client software for presenting a context at a PTT client.

FIG. 10 is a flowchart of an example of a technique for providing context in server-based implementations of a PTT system.

FIG. 11 is a flowchart of an example of a technique for receiving a context in server-based implementations of a PTT system.

FIG. 12 is a flowchart of an example of a technique for providing context in P2P implementations of a PTT system.

### DETAILED DESCRIPTION

In a PTT system, multiple PTT client devices (or simply PTT clients), such as walkie-talkies or mobile phone applications, communicate either directly with each other in a P2P manner or through a central server, depending on the PTT system architecture. When a user presses the PTT button on their device, their voice is transmitted as an audio message (or simply as a message) to other users in the same channel or group. In server-based systems, the server manages the routing of these transmissions, ensuring that the an audio message received from one PTT client is broadcast to all other connected devices. In P2P systems, each device communicates directly with others, allowing for decentralized and often more resilient communication. In either configuration, the communication is real-time, with the user's audio being transmitted while the PTT button is pressed, and the transmission from the user's device terminates when the button is released.

In some cases, multiple PTT users may be involved in a conversation. Conventional PTT systems, with their ephemeral nature, present significant limitations in providing context to users who join a conversation after it has started. In this setting, “ephemeral” means that communications are transient and exist only at the moment they are transmitted, with no capability to replay or review past messages; and “context” refers to the data related to prior relevant messages with respect to a particular audio message. This data can be, for example, a summary of the prior relevant messages or the prior relevant messages themselves.

Without access to this context, PTT users (also referred to herein as “users”) who join a PTT channel mid-conversation are unable to retrieve earlier messages that provide the necessary background to understand the ongoing discussion. This lack of context can lead to interruptions, where users must ask for repetitions or explanations, causing inefficiencies and increasing the risk of misunderstandings. The lack of technical capabilities in conventional PTT systems to identify and deliver contextual data related to an audio message disrupts the continuity of discussions, often resulting in incomplete task execution, errors, or delays in decision-making.

Implementations according to this disclosure solve problems such as these via PTT systems that identify and deliver context to users with respect to an audio message. A PTT system according to this disclosure enables users to, for example, access (e.g., replay or view) prior messages within a PTT channel, ensuring that all users can obtain the necessary context for ongoing discussions. The PTT system enables users who join a channel later in its lifecycle to retrieve past messages relevant to a current conversation, thereby gaining the context needed to fully understand and engage in the discussion. The PTT system identifies a current topic a conversation and prior messages relevant to the topic of conversation.

The PTT system may enable channels to be configured with options or rules (i.e., context generation rules) related to how and which prior audio messages are used in identifying the context. The context generation rules can be tailored for each channel and/or each user. For instance, the context generation rules may specify that context is based on a specific time duration (e.g., the last five minutes), a set number of previous messages (e.g., the last more relevant previous messages), or by leveraging natural language understanding (NLU) to identify and present the most relevant messages related to a current topic. Such context-aware retrieval capabilities enable users to quickly catch up on prior exchanges, minimizing disruptions and significantly enhancing communication efficiency. By providing this level of flexibility and precision in message retrieval, PTT systems according to this disclosure represent further improvements over traditional PTT systems, which are limited by their ephemeral nature and lack of contextual awareness.

In some examples of the present disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

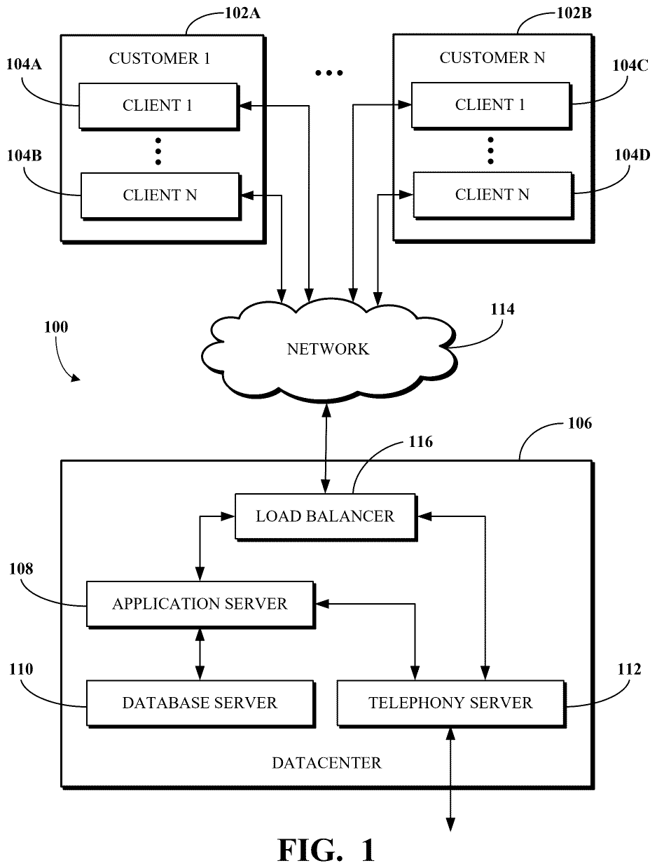

To describe some implementations in greater detail, reference is first made to examples of hardware and software structures used to implement a system for providing context to a client device joining a PTT channel. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a unified communications as a service (UCaaS) platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, an SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, an SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

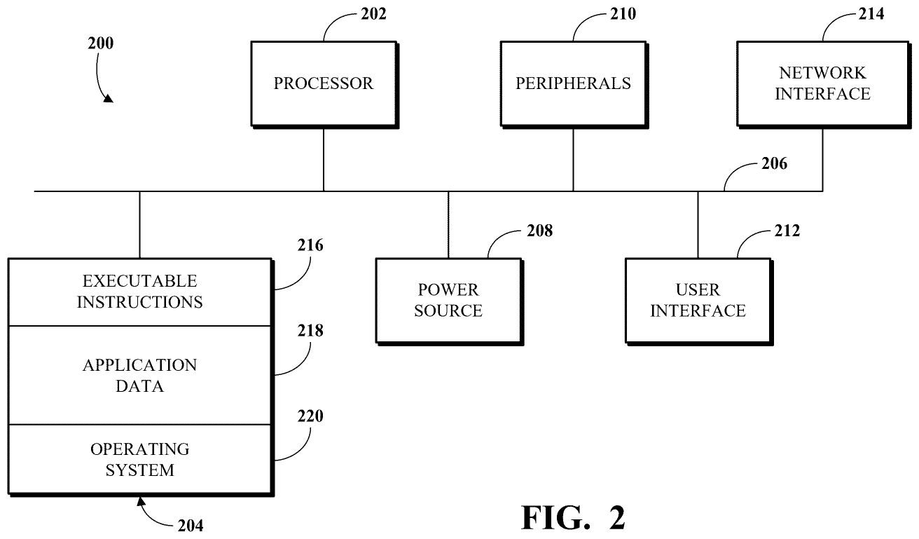

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

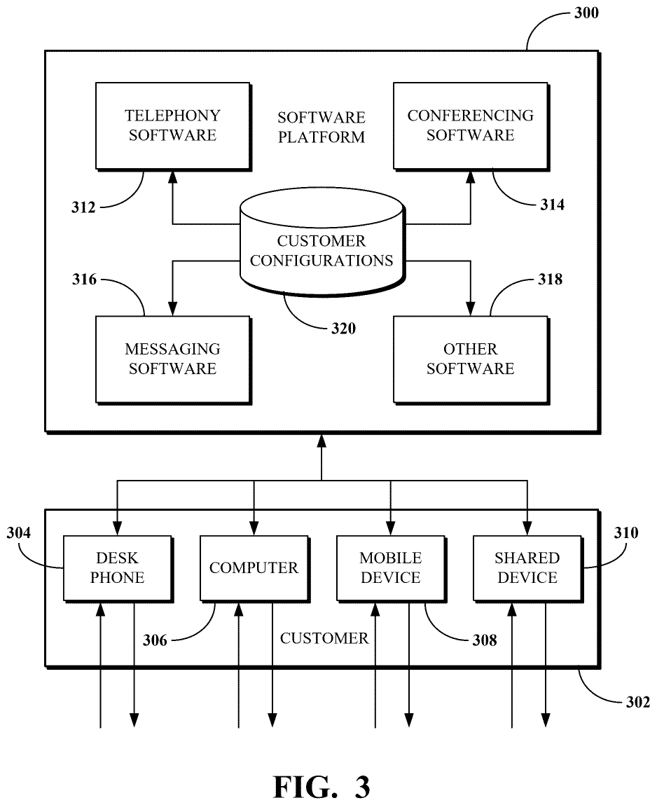

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include PTT software configured to implement a PTT channel and/or provide context to a client device that joins a PTT channel.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

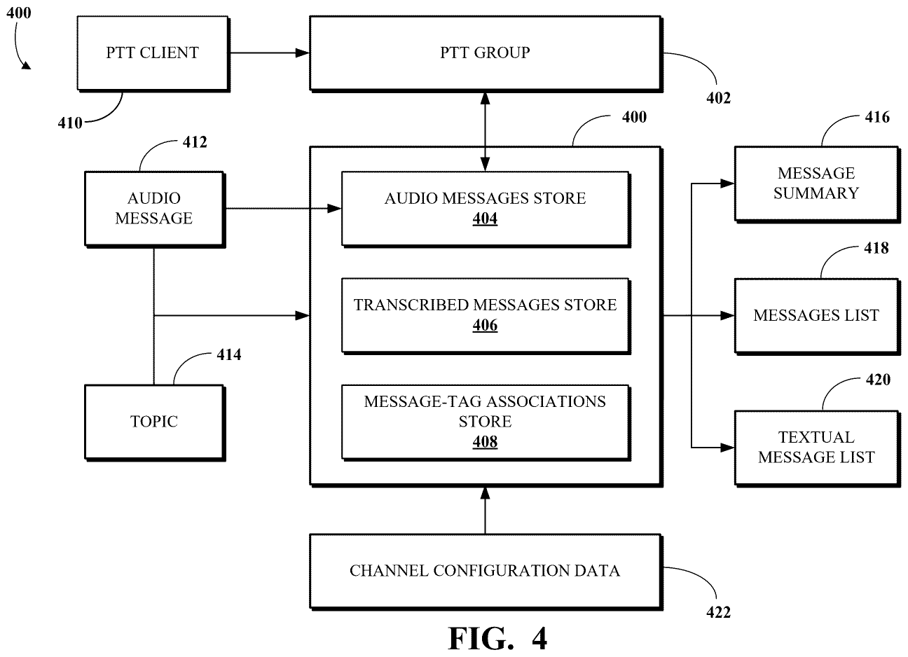

FIG. 4 illustrates a high-level, logical architecture of a PTT system 400 designed for identifying contexts for audio messages. The PTT system 400 includes several components that work together to store, process, and retrieve audio messages or data derived therefrom, enabling users who join a PTT channel mid-conversation to access contextually relevant information and stay informed about the ongoing conversation.

A PTT group 402 represents a PTT channel, which functions as a virtual communication space where multiple PTT clients (not shown), such as smartphones, walkie-talkies, or other custom user devices, can connect to participate in real-time PTT voice communication. Any number of PTT clients may join the PTT group 402. Each of the PTT clients may correspond to at least one of the clients 104A-D of FIG. 1 or to one of the clients 304 through 310 of FIG. 3. When a PTT client in the PTT group 402 transmits an audio message, the message is played back on the other user devices within the PTT group 402. Although FIG. 4 depicts a single PTT group (e.g., the PTT group 402), the disclosed technology is scalable and can be implemented across multiple PTT groups simultaneously.

Each device within the PTT group 402 can transmit and receive audio messages, contributing to an ongoing conversation. These audio messages are stored in an audio messages store 404. Depending on the architecture of the PTT system 400—whether it is server-based or P2P, as further described herein—the audio messages store 404 can be centralized on a server or decentralized across the devices in the PTT group 402. In a decentralized configuration, each audio message may be stored on the originating PTT client. An audio message may also be stored on every PTT client that receives the audio message.

Each stored audio message can be associated with metadata, including the identity of the sending user (e.g., a telephone number or username), a timestamp indicating when the audio message was transmitted, and possibly additional information such as the channel ID or priority level. The audio messages store 404 serves as a historical record that can be accessed later for context retrieval, allowing users who join the PTT group 402 afterward to catch up on the conversation by obtaining (e.g., retrieving or generating) the relevant context.

The PTT system 400 may include a transcription capability (not shown) that processes the audio messages stored in the audio message store 404 and converts them into text (e.g., transcribed messages), which are then stored in the transcribed messages store 406. These transcribed messages can be stored centrally or distributed across devices, depending on the architecture of the PTT system 400. The speech-to-text conversion facilitates text-based search, analysis, and display functions, enabling users to interact with the content in various formats.

The transcribed messages can be stored in a structured format that allows for efficient indexing and retrieval. Indexing may involve creating references based on keywords, timestamps, or associated topics, making it easier to quickly locate relevant messages. These transcribed messages are particularly useful for generating summaries, enabling text-based search queries, or providing accessibility features (e.g., for users who prefer reading over listening).

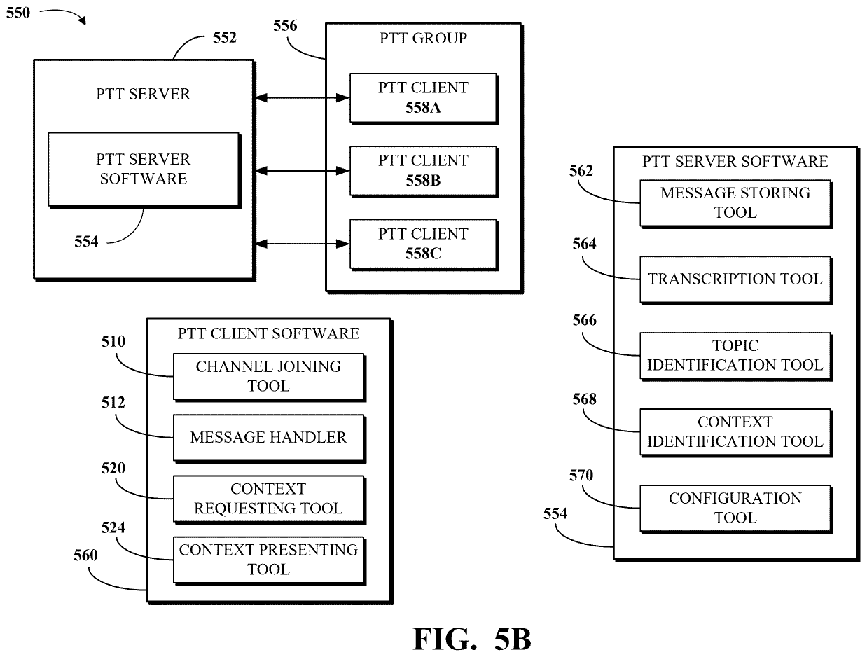

The transcribed messages may undergo analysis to associate tag therewith. Each transcribed message and/or audio message can be associated with one or more tags in a message-tag associations store 408. This analysis can be performed, such as described with respect to FIG. 6, using NLU that identifies and associates labels, entities, topics, keywords, urgency levels, and/or other descriptors with the messages. To illustrate, if the conversation is about a ‘product launch,’ messages related to that topic would be tagged accordingly; and if a first audio message was ‘Are you planning on watching the Olympics?’ and a second, subsequent message was ‘I am looking forward to watching Simone Biles,’ the first message may be tagged with ‘Olympics,’ while the second message may be tagged with ‘Olympics,’ ‘Simone Biles,’ and ‘Gymnastics.’ These tags enable the PTT system 400 to filter and sort messages based on relevance, allowing for more targeted retrieval of prior messages when a user requests context.

FIG. 4 further illustrates the scenario where a new PTT client (e.g., a PTT client 410) joins the PTT group 402. At the time that the PTT client 410 joins the group, an audio message 412 is transmitted through the channel. This audio message 412 may be the first message that the user of the PTT client 410 hears in whole or in part, and thus, it may be useful for the PTT system 400 to provide context for this message. In addition to storing the audio message 412 in the audio messages store 404, the PTT system 400 uses it to generate context for the user. Furthermore, a user within the PTT group 402 may request context related to a specific topic (e.g., a topic 414).

Upon receiving a new audio message (e.g., the audio message 412) or the topic 414, the PTT system 400 triggers a process to generate a context-based output according to one or more context formats. The topic 414 may be user-defined or automatically detected based on ongoing conversations. The context-based output may include one or more of the following: a message summary 416, a messages list 418, or a textual message list 420.

The message summary 416 provides a condensed version of the most relevant messages, offering a quick overview of the ongoing conversation. The messages list 418 contains actual audio messages (e.g., a subset of the audio messages stored in the audio message store 404) that are relevant to the ongoing conversation (e.g., the audio message 412) or the topic 414, selected from the audio messages store 404 based on their tags and other contextual factors. The textual message list 420, similar to the messages list 418, provides a list of transcribed messages in text format, which can be useful for users who need to quickly skim through the conversation or for those in environments where listening to audio is not feasible.

The generation of these context-based outputs may involve applying or may be based on channel configuration data 422, which includes rules and preferences on how messages should be selected, summarized, and presented to the user.

The channel configuration data 422 includes various parameters that control how the PTT system 400 operates. The channel configuration data 422 may include settings for message retention periods, priority rules, tagging criteria, and user-specific preferences. The channel configuration data 422 may include context generation rules usable to tailor the context retrieval process to specific needs, such as prioritizing certain types of messages (e.g., emergency alerts) or filtering out irrelevant content based on user preferences. Users or administrators can customize these settings to optimize the system's behavior, ensuring that the generated outputs (e.g., the message summary 416, the messages list 418, the textual message list 420) meet their specific requirements.

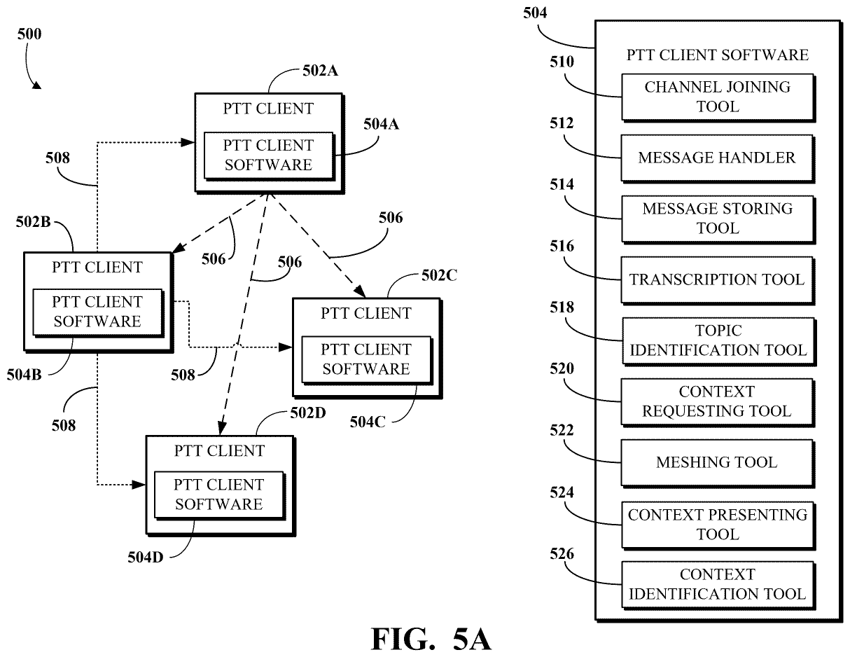

FIG. 5A illustrates a P2P configuration of a PTT system 500. FIG. 5A shows an example scenario in which four PTT clients (e.g., PTT clients 502A, 502B, 502C, and 502D) connected to a PTT channel (not shown) communicate directly with one another without relying on a central server. Each PTT client, such as PTT client 502A, incorporates a PTT client software 504 (e.g., PTT client software 504A), which facilitates PTT communication and context retrieval. FIG. 5A further illustrates that an audio message 506 is transmitted from the PTT client 502A and received by the PTT clients 502B, 502C, and 502D; and an audio message 508 transmitted from the PTT client 502B is received by the PTT clients 502A, 502C, and 502D.

The PTT client software 504 can include programs, subprograms, functions, routines, subroutines, operations, executable instructions, and/or the like for, inter alia and as further described herein, facilitating the operations of context identification and retrieval in a P2P communication system. The PTT client software 504 is shown as including a channel joining tool 510, a message handler tool 512, a message storing tool 514, a transcription tool 516, a topic identification tool 518, a context requesting tool 520, a meshing tool 522, a context presenting tool 524, and a context identification tool 526.

The channel joining tool 510 is configured to manage the process by which a PTT client device joins an existing PTT channel within the P2P network. The channel joining tool 510 may enable the PTT client to discover available PTT channels, establish connections, and integrate into the ongoing communication within a PTT channel. The channel joining tool 510 may manage the exchange of necessary credentials and channel-specific data to ensure seamless participation in the PTT channel. In an example, the channel joining tool 510 may receive, such as from a directory or the like a list of channels that the user associated with the PTT client is enabled (e.g., configured) to access.

The message handler tool 512 is configured to manage the real-time transmission and reception of audio messages between the PTT client and other PTT clients associated with a PTT channel. The message handler tool 512 may encode and transmit outgoing audio message and may decode and output incoming audio messages.

The message storing tool 514 is configured to manage the local storage of audio messages at the PTT device. In a P2P configuration, the message storing tool 514 manages the decentralized storage of messages, ensuring that each PTT client stores relevant audio data along with associated metadata such as timestamps, sender identity, message tags, and the PTT channels the audio messages are associated with. In an example, the message storing tool 514 may locally store only outgoing message. In an example, the message storing tool 514 may also locally store received audio messages.

The transcription tool 516 facilitates the conversion of audio messages into text. The transcription tool 516 uses speech-to-text algorithms, such as Automatic Speech Recognition (ASR), to transcribe the stored audio messages into a textual format, enabling text-based search, analysis, and display. The transcribed messages can be indexed for efficient retrieval and may also be tagged with relevant topics or keywords to enhance searchability.

The topic identification tool 518 is configured to analyze the content of a transcribed audio message to identify tags to associate therewith. Using NLP techniques, the topic identification tool 518 tags messages with (e.g., associates with the messages) relevant topics, which can be used to filter and prioritize messages to identify a context. The topic identification tool 518 may organizing the conversation history, making it easier for the user to navigate through past messages related to specific topics. The topic identification tool 518 stores associations between messages and tags in a message-tag associations store, such as the message-tag associations store 408 of FIG. 4.

The context requesting tool 520 enables the PTT client to request and retrieve prior context from other PTT clients in the PTT channel, such as when the PTT client joins a PTT channel mid-conversation. The context requesting tool 520 transmits context requests to the other PTT clients in the PTT channel and manages the incoming context data, which includes transcriptions and/or audio messages and also includes associated metadata.

The context requests may include a set of tags associated with an audio message, such as the first audio message, or a portion thereof, received at the PTT client after the PTT client joined the channel. As such, tags are first identified with respect to the audio message so that they can be included in the context requests.

The context requests may include one or more context formats. A context format indicates the type of context to be received. For example, the context formats may specify whether the response should include a message summary, a messages list, a textual message list 420, or a combination thereof.

The meshing tool 522 is configured to organize and integrate the context data received from multiple PTT clients. The meshing tool 522 meshes the received messages by arranging them in chronological order and removing duplicates to obtain a coherent sequence of messages. The meshing tool 522 ensures that the user receives a clear and concise history of the conversation, enabling them to catch up on what was discussed before they joined the channel.

The context presenting tool 524 is configured to deliver the retrieved and meshed context to the user. Once the context requesting tool 520 and the meshing tool 522 have organized and processed the relevant past messages, the context presenting tool 524 ensures that this information is presented to the user in a way that aligns with their preferences and the capabilities of the PTT client.

The context presenting tool 524 can deliver (e.g., present or output) the context in various formats, such as audio, text, or graphical summaries. For instance, if the PTT client includes a display, the context presenting tool 524 may present the context as a list of transcribed messages or a textual summary of the messages used to derive the context. In environments where the user cannot or prefers not to read text, the context presenting tool 524 can utilize text-to-speech technology to audibly play back the context.

The context presenting tool 524 may allow the user to interact with the presented context, such as by scrolling through previous messages, selecting specific messages for detailed review, or choosing to skip to the most recent messages. The context presenting tool 524 can also provide visual or auditory cues to indicate the relevance and importance of different parts of the context, ensuring that the user is quickly brought up to speed on the most critical aspects of the conversation.

The context identification tool 526 is configured to respond to context requests received from the context requesting tool 520 of another PTT client. As mentioned, a context request may include one or more tags. The context identification tool 526 uses these one or more tags to identify messages for the context by matching the one or more tags to the tags associated with the messages stored at the PTT client.

FIG. 5B illustrates a server-based configuration of a PTT system 550. As shown the PTT system 550 includes a PTT server 552, which includes or implements a PTT server software 554, and PTT group 556 that includes multiple PTT clients, such as PTT clients 558A-558C.

Each of the PTT clients includes a PTT client software 560. While three PTT clients (e.g., the PTT clients 558A-558C) are illustrated, the disclosed technology may be implemented with other numbers of PTT clients. The PTT server 552 may correspond to the application server 110. Each of the PTT clients 558A-558C may correspond to at least one of the clients 104A-D or to one of the clients 304 through 310 of FIG. 3.

The multiple PTT clients 558A-558C form the PTT group 556. When one of the PTT clients (e.g., the PTT client 558A) from the PTT group 556 transmits an audio message, the audio message is played back at the other PTT clients (e.g., the PTT clients 558B-558C) in the PTT group 556. The audio message is transmitted to the PTT server, which in turn broadcasts the audio message to the PTT clients in the PTT group. While a single PTT group (e.g., the PTT group 556) is illustrated in FIG. 5B, the disclosed technology may be implemented with multiple PTT groups. Some of the multiple PTT groups may share a PTT server (e.g., the PTT server 552) or some of the multiple PTT groups may have their own PTT server.

The PTT server software 554, implemented on the PTT server 552, manages centralized communication, storage, and processing functions for the PTT group 556. The PTT server software 554 can be implemented by a software platform, such as the software platform 300 of FIG. 3. As such, the PTT server software 554 can be or can be included in the other software 318 of FIG. 3. The PTT server software 554 can include tools that correspond to or perform functions similar to those described with respect to the PTT client software 504 of FIG. 5A, but with server-based functionalities. These functionalities include centralized storage of audio messages, unified transcription processing, centralized topic identification, and configuration control, offering benefits like consistent data management, greater scalability, and enhanced control over the operations of the PTT group 556. Specifically, the PTT server software 554 is shown as including a message storing tool 562, a transcription tool 564, a topic identification tool 566, a context identification tool 568, and a configuration tool 570.

The message storing tool 562 performs similar functions to the message storing tool 514 described in FIG. 5A, but operates in a centralized manner. In this server-based configuration, the message storing tool 562 stores audio messages transmitted by any PTT client within the PTT group 556 centrally on the PTT server 552 and there is no need for each of the PTT clients to store audio messages. The central storage ensures that the entire conversation history is preserved in a single location, allowing any PTT client joining the channel to retrieve the complete context from the server.

The transcription tool 564 performs similar functions to the transcription tool 516 described in FIG. 5A, converting audio messages into text using speech-to-text algorithms. In this server-based configuration, the transcription tool 564 processes all audio messages centrally on the PTT server 552, ensuring consistent and unified transcription across all PTT clients within the PTT group 556.

The topic identification tool 566 performs similar functions to the topic identification tool 518 described in FIG. 5A, identifying key topics, entities, or themes within transcribed messages. By centralizing this function on the PTT server 552, the system ensures that all PTT clients within the PTT group 556 can access a consistent and comprehensive set of topics and tags associated with the conversation.

The context identification tool 568 identifies a context with respect to (e.g., for) an audio message. The context identification tool 568 operates similarly to the context identification tool 526 of FIG. 5A. As such, the context identification tool 568 uses tags to identify messages for the context by matching the tags associated with a message to the tags associated with the messages stored at the PTT server.

The configuration tool 570 enables administrators to define global rules for message retention, access control, channel creation, and participant roles. The configuration tool 570 ensures that all PTT clients within the PTT group 556 adhere to the same policies, providing a controlled and secure communication environment.

The PTT client software 560 shown in FIG. 5B includes several tools that perform similar functions to the tools described in FIG. 5A, including the channel joining tool 510, message handler tool 512, the context requesting tool 520, the context presenting tool 524. These tools operate in coordination with the server-based tools to ensure that PTT clients can seamlessly join the channel, participate in conversations, and retrieve relevant context, all while relying on the centralized resources provided by the PTT server 552.

A channel configuration may include or define a channel roster. The channel roster can include a set of users or a set of rules that identify which users can join or participate in a PTT channel. A channel roster may specify individual users by their unique identifiers (e.g., usernames or email addresses). A channel roster may apply rules that automatically include users based on certain criteria. To illustrate, a PTT channel may be configured to allow access only to users marked as “MANAGER” in a directory of employees.

A channel configuration can include a context generation rule. In an example, a context generation rule can include criteria for selecting which prior messages should be used (e.g., included) when generating a context. For instance, the context generation rule may indicate prioritizing messages tagged with certain keywords or topics, ensuring that the most relevant parts of the conversation are highlighted. The context generation rule may specify that messages containing critical instructions or alerts should always be included, regardless of when they were sent, to ensure that the participant is immediately aware of any important developments. A context generation rule may indicate that M prior messages related to a topic should be used as context, that the context is to be extracted from the last N prior messages, that the context is to be extracted from all messages related to a topic amongst messages exchanged in the last P minutes, or that the context should include all high-priority messages exchanged within the last Q hours, where M, N, P, and Q are positive integers.

Context generation rules can also be user specific. To illustrate, the context generation rule associated with one class of users (e.g., managers) may indicate that a more comprehensive set of prior messages, such as the last 20 messages or all messages exchanged within the last 60 minutes, should be provided as context, while the context generation rule associated with another class of users (e.g., non-managers) may specify a smaller set of prior messages, such as the last 5 messages or only the messages exchanged within the last 10 minutes. This ensures that each user receives the level of context appropriate to their role, enabling managers to have a more in-depth understanding of ongoing discussions, while other users receive only the most essential information.

The configuration tool 570 can also define policies for message retention within the PTT server. For instance, a PTT channel may be configured such that all messages within the channel are retained for a period of 7 days, after which the messages are automatically deleted. In another example, a channel configuration may include a rule that specifies that all messages within a PTT channel are automatically deleted when no PTT clients are connected to that channel. At certain points in time, no PTT clients may be connected to a PTT channel. In such cases, messages can be retained from the moment the first PTT client joins the channel until the point when the last PTT client disconnects from the channel.

In yet another example, the configuration tool 570 may allow for customized settings based on the type of communication or the specific needs of a PTT group. For example, a channel used for emergency response might have a configuration where all messages are retained indefinitely, and the context provided to new participants includes the entire conversation history, regardless of time or message count. On the other hand, a casual discussion channel might limit the context to the last three messages or the last five minutes of conversation, focusing on brevity and relevance.

The configuration tool 570 may also be configured to define exclusion rules for providing context to new participants in a PTT channel. Specifically, such exclusion rules enable administrators or moderators to determine whether certain users should receive historical context upon joining the PTT channel. The exclusion rules may take into account factors such as the user's role, the time elapsed since the channel was initiated, or the nature of the conversation. For instance, certain users may be explicitly excluded from receiving context if they join after a critical point in the discussion, where sensitive or proprietary information was shared.

The exclusion rules can be customized on a per-user or per-group basis, thereby offering precise control over who has access to prior messages. The configuration tool 570 can also define exclusion policies that are time-bound. For example, a user joining after 30 minutes of ongoing conversation might be excluded from receiving the context, whereas a user joining within the first five minutes might still receive a context summary. By configuring these exclusions, the PTT server software 554 can ensure that sensitive or privileged information is not shared with users who do not have the appropriate permissions or who join after the relevant information has been disseminated.

Additionally, the configuration tool 570 may provide administrators with an interface to dynamically adjust these exclusion settings during a live session. This feature allows for real-time modifications to the exclusion rules based on the evolving nature of the conversation. For example, if a discussion shifts from a general topic to a more sensitive one, the PTT server software 554 can be reconfigured to exclude late-joiners from receiving context about that particular part of the discussion.

A current participant in a PTT channel may enter a command (such as a verbal command, a key combination on a keypad, or via a user interface control) which the configuration tool 570 interprets to restrict context sharing for subsequent users joining the channel. Specifically, once this command is entered, any user joining the PTT channel after that point will be excluded from receiving context related to messages preceding the command. This functionality provides participants with the ability to immediately adjust the flow of information during a conversation, ensuring that, for example, sensitive or context-specific details remain restricted to those who were part of the discussion up until that moment.

FIG. 6 is a block diagram of a topic identification tool 600, which can be the topic identification tool 518 of FIG. 5A or the topic identification tool 566 of FIG. 5B. The topic identification tool 600 is shown as including an AI engine 602. The topic identification tool 600 receives a new transcribed message 604 of an audio message and identifies tags (e.g., topics) to associate with the audio message.

The AI engine 602 is designed (e.g., trained) to analyze the content of the new transcribed message 604 and determine the key topics discussed within that message. The AI engine 602 processes the text using advanced NLP algorithms, which allow it to understand the semantics and context of the new transcribed message 604. The AI engine 602 may also leverage a large language model (LLM) to enhance its understanding of complex language patterns, making it more effective in identifying nuanced or context-dependent topics. As part of its operation, the AI engine 602 can also access prior transcribed messages 606 and prior tags 608 associated therewith from an ongoing PTT session. The prior transcribed messages 606 and prior tags 608 provide additional context that helps the AI engine 602 maintain consistency in topic identification across the PTT session.

A PTT session is established when the first PTT client joins a PTT channel and is maintained as long as at least one PTT client remains connected to the PTT channel. The PTT session concludes when all PTT clients have disconnected from the channel. Thus, PTT sessions are initiated and terminated based on PTT client participation. To illustrate, consider a PTT channel created for a project team. When the first team member joins the PTT channel, a PTT session is initiated. As additional team members join, they contribute to the ongoing session. The PTT session continues as long as at least one member remains connected. When the last member disconnects from the PTT channel, the PTT session ends, and the PTT channel becomes inactive until a new PTT session is started by another member joining the PTT channel.

The AI engine 602 may first preprocess the text of the new transcribed message 604, breaking it down into tokens, which are smaller units such as words or phrases. The AI engine 602 may then remove any stop words, which are common words like “and,” “the,” and “is,” that do not significantly contribute to the meaning of the text. This preprocessing step ensures that only meaningful content is used by the AI engine 602.

After preprocessing, the AI engine 602 may employ topic modeling techniques to identify the underlying themes or topics within the new transcribed message 604. Various techniques can be used for this purpose. One such technique is Latent Dirichlet Allocation (LDA), which is a statistical model that assumes each document—or in this case, each transcribed message—is a mixture of a small number of topics, and each topic is a distribution over words. The AI engine 602 may assign probabilities to each word in the message, determining the likelihood that the word belongs to a particular topic. The AI engine 602 may then cluster these words into coherent topics, effectively identifying the main subjects of discussion in the new transcribed message 604. If an LLM is integrated, it can further refine this process by recognizing more abstract or context-sensitive topics that may not be as easily detected by traditional statistical methods.

The AI engine 602 may integrate the new tags with those identified in the prior transcribed messages 606 and prior tags 608. This integration can be useful in maintaining the relevance and consistency of topic identification throughout the PTT session. The AI engine 602 may compare the topics from the new transcribed message 604 with those from the prior transcribed messages 606, adjusting and refining the topic assignments to ensure that they accurately reflect the ongoing conversation. The use of an LLM can enhance this process by providing deeper contextual understanding and more accurate topic continuity.

Once the AI engine 602 has identified and contextualized the topics, it may generate the tags 610 that are to be associated with the new transcribed message 604 and/or the corresponding audio message. As described herein, the tags 610 serve as metadata that can be used to categorize, search, and retrieve messages based on their content. For example, if the AI engine 602 identifies topics like “budget,” “timeline,” and “project risks” in the transcribed message, it will create corresponding tags that can be stored with the message in the PTT system's database.

In some implementations, the topic identification tool 600 associates tags with prior messages in a PTT session on demand. When a context is requested, the prior transcribed messages 606 in the PTT session, along with a new transcribed message 604, are analyzed to identify tags associated therewith. This on-demand tagging approach allows the topic identification tool 600 to leverage the full scope of the conversation, including both historical and recent messages, to generate more accurate and contextually relevant tags. By analyzing a larger body of text, the AI engine 602 can better understand the evolving context and nuances of the discussion, resulting in more precise and meaningful tags that accurately reflect the entire conversation. This leads to improved information retrieval and ensures that the generated context is highly relevant to the current state of the PTT session.

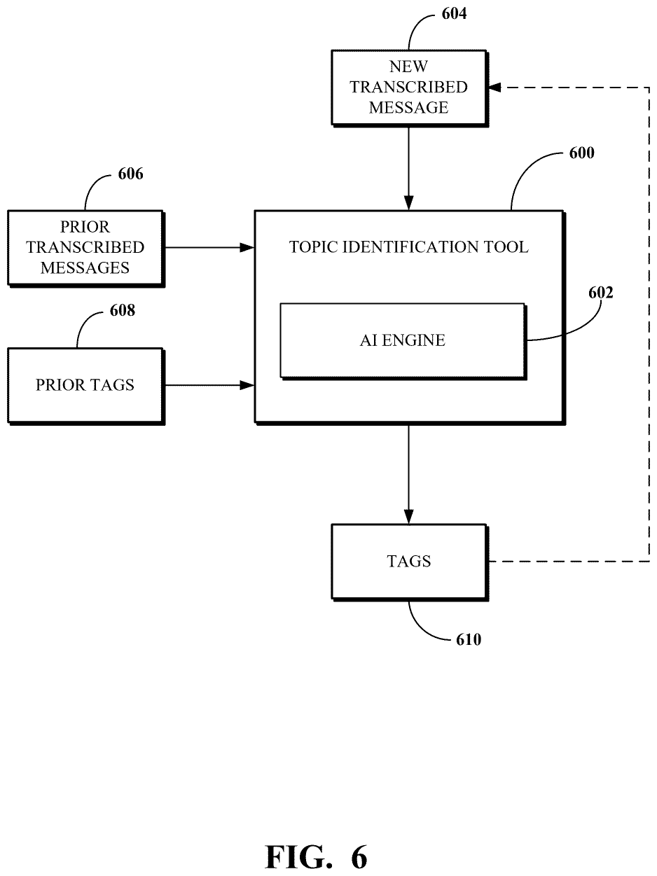

FIG. 7 is a flow diagram 700 for generating context in a server-based PTT system. The flow diagram includes a PTT group 702 that includes PTT clients (not shown), a user device 704 that is not yet part of the PTT group 702, and a PTT server 706. The PTT group 702 can be the PTT group 402 of FIG. 4 or the PTT group 556 of FIG. 5B. The PTT server can be the PTT server 552 of FIG. 5B. At 708 and 710, the flow diagram 700 shows that PTT clients within the PTT group 702 transmit audio messages to the PTT server 706; and the PTT server 706 then retransmits these messages to the other PTT clients in the group.

At 712, a request is transmitted from the user device 704 to join the PTT group 702. For example, via PTT client software, such as the PTT client software 560 of FIG. 5B, of the user device 704, a user associated with the user device 704 can cause the request to be transmitted to the PTT server 706. For example, via a user interface of the PTT client software, the user may select a channel associated with the PTT group 702 and cause the request to join the channel to be transmitted to the PTT server 706.

At 714, the PTT server 706 receives the request from the user device 704 and processes the request. The PTT server 706 then accepts the request and, at 716, adds the user device 704 to the PTT group 702. Once the user device 704 is added to the PTT group 702, it becomes a PTT client and can begin participating in the communication within the group. The user device 704, now a part of the PTT group 702, can then transmit its own audio messages.

As or after the user device 704 is added to the PTT group, one of the PTT clients, other than the user device 704, transmits a PTT audio message, at 718. While not specifically shown in the flow diagram 700 for brevity, the PTT server 706 receives the PTT audio and retransmits it to all other PTT clients of the PTT group 702. At As such, the user device 704 may receive at least a portion of the PTT audio message.

At 722, the PTT server 706 proceeds to identify a context for the PTT audio message. In an example, the PTT server 706 determines that the PTT audio message is a first audio message received by the user device 704 since the user device 704 was added to the PTT group 702 and proceeds to automatically identify the context based on the determination. As the user device 704 joins the PTT group 702 during an ongoing conversation, the user may lack the context of the prior exchanges within the PTT channel.

In a variant of the flow diagram 700, a request for the context may be received from the user device 704. The user of the user device 704, or any other PTT client of the PTT group 702, may request context with respect to any audio message received at the requesting device. To illustrate, after receiving an audio message at a PTT client, the user may cause a request for context to be transmitted to the PTT server 706. The PTT server 706, having a history of the latest audio message transmitted, identified the context for that message.

The flow diagram 700 illustrates that, after the PTT server 706 identifies the context at 722, it transmits an indication of the context to the user device 704. That is, the PTT server 706 indicates to the user device 704 that a context is available is the user of the user device 704 would like that context. However, in another implementation, the PTT server 706 may just transmit the context to the user device 704.

Once the context or indication of context is received, the PTT client software may notify the user of its availability. For example, the software may output an audible indicator (e.g., a double beep) or a visual indicator (e.g., an icon or image) on the user device 704. At 726, the user may request the context by pressing a key combination or selecting a user interface control, prompting the PTT client software to transmit the request to the PTT server 706. At 728, the PTT server 706 transmits the context to the user device 704, which then outputs it to the user at 730. The context may include audio playback of prior messages, text summaries, or other relevant information, helping the user catch up on the ongoing conversation within the PTT group 702.

In a variant of the flow diagram 700, whether a context is identified and transmitted to the user device 704 can depend on configuration rules of the PTT channel. The PTT server 706 first verifies if the joining user meets the conditions for receiving prior context, such as defined by exclusion rules configured for the channel. If the configuration rules specify that the user should not receive the historical context (e.g., due to their late entry or their user role), the PTT server 706 denies the context request and only provides real-time audio messages.

As described with respect to FIG. 5B, if a command is entered by a current participant, the PTT server 706 interprets it to indicate that any user joining after this point of entry of the command should not be provided with context for messages preceding the point where the command was entered.

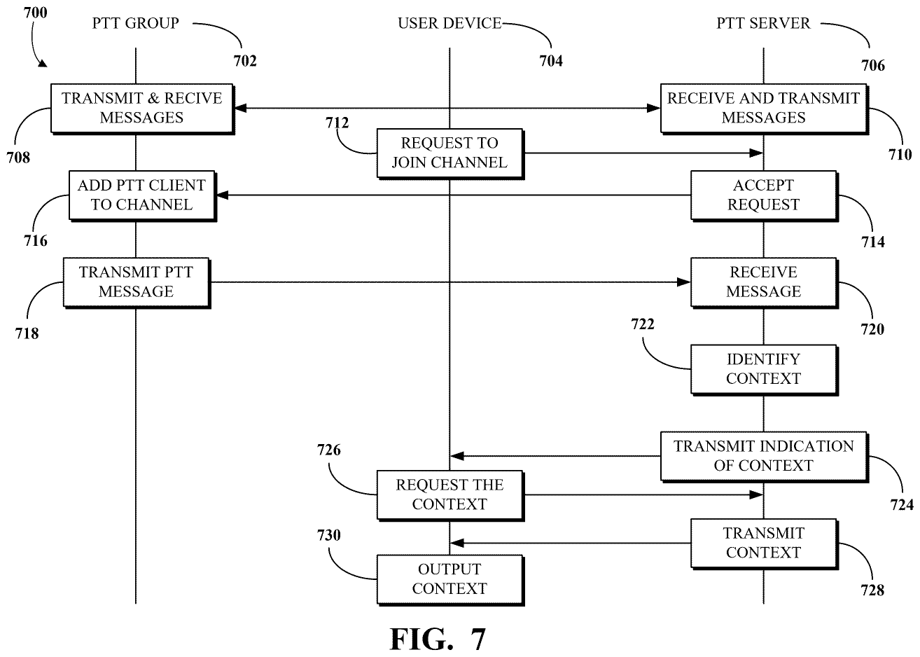

FIG. 8 is a flow diagram 800 for generating context in a P2P PTT system. The flow diagram 800 illustrates a first PTT client 802 and a second PTT client 804 that are part of a PTT group (not shown). The PTT group may include additional PTT clients beyond the first and second PTT clients. A user device 806 is not yet part of the PTT group. The PTT group can be the PTT group 402 of FIG. 4 or the PTT group 556 of FIG. 5B. At 808 and 810, the flow diagram 800 shows that the PTT clients within the PTT group transmit and receive audio messages in a P2P fashion. Each of the first PTT client 802, the second PTT client 804, and the user device 806 includes a respective PTT client software, which can be the PTT client software 504 of FIG. 5A.

At 812, the user device 806 transmits a request to join the PTT group. For example, the user device 806 may utilize PTT client software, such as the PTT client software 504 of FIG. 5A, to initiate the request. Once the request is processed, the user device 806 is added to the PTT group and becomes capable of participating in the ongoing PTT communication.

After joining the PTT group, the first PTT client 802 transmits a message in the PTT channel. The second PTT client 804 receives and outputs the message at 816A and the user device 806 receives and outputs the PTT message at 816B. This message may be the first message received by the user device 806 since joining the group.

Once the message is received at the user device 806, the topic of the message may be identified at 818, such as by a topic identification tool of the PTT client software. The topic identification process may involve analyzing the content of the message to determine the key subjects being discussed. This analysis can be facilitated by the PTT client software on the user device 806, which may employ an AI engine, as described with respect to FIG. 6, to accurately identify topics. As described above, one or more tags can be associated with the message.

At 820, the user device 806 may request context for the received message. The request for context is sent to the other PTT clients in the PTT group, such as the first PTT client 802 and the second PTT client 804. The request can include the topic (e.g., the tags) identified at 818. Each of these PTT clients may have stored portions of the conversation that occurred before the user device 806 joined the group.

Additionally, at least one of the first PTT client 802 or the second PTT client 804 may include messages transmitted by one or more PTT clients that are no longer in the PTT group. For example, a third PTT client (not shown) and the second PTT client 804 may have been in the PTT group prior to the first PTT client 802 joining the group. In this scenario, the first PTT client 802 may have requested context from the third PTT client and the second PTT client 804 when it first joined the group, thereby storing messages transmitted by the third PTT client, which is no longer in the PTT group. This ensures that even messages from former group members can be included in the context provided to new participants, enriching the completeness of the context.

The first PTT client 802 and the second PTT client 804, upon receiving the request for context, transmit the relevant context to the user device 806 at 822A and 822B, respectively. This context may include prior messages or other information that provides the necessary background for the current conversation. A context requesting tool (e.g., the context requesting tool 520 in FIG. 5A) can be configured to handle requests for context, including sending and receiving such requests. In this scenario, when the first PTT client 802 and the second PTT client 804 receive a context request from the user device 806, their respective context identification tools process the request, retrieve the relevant stored messages or context, and then transmit that context back to the requesting user device 806.

At 824, the user device 806 meshes, such as by a meshing tool of the PTT client software, the received contexts from the first and second PTT clients to form a coherent sequence of events or topics. This meshing process involves organizing the received messages chronologically, removing duplicates, and ensuring that the context is presented in a logical and understandable manner.

At 826, the meshed context can be output to the user on the user device 806. The meshed context can be output as described with respect to 730 of FIG. 7. The context may be presented in various formats, such as text, audio playback, or graphical summaries, depending on the capabilities of the user device and the preferences of the user. This ensures that the user is fully informed of the ongoing conversation and can participate meaningfully in the PTT group.

In a variant of the flow diagram 800, the extent to which the context is provided can depend on a configuration of the PTT channel. For example, if a current participant enters a command, the configuration rules may dictate that any user joining the PTT channel after this point should not receive context for prior messages. In another example, and while not specifically described with respect to FIG. 5A, the PTT client software of a PPT client may enable the configuration of exclusion rules that determine whether joining users receive context. These exclusion rules can be based on criteria such as the time of joining, the user's role, or the specific command given by an existing participant. Depending on these rules, the PTT client software may selectively withhold or provide historical context.

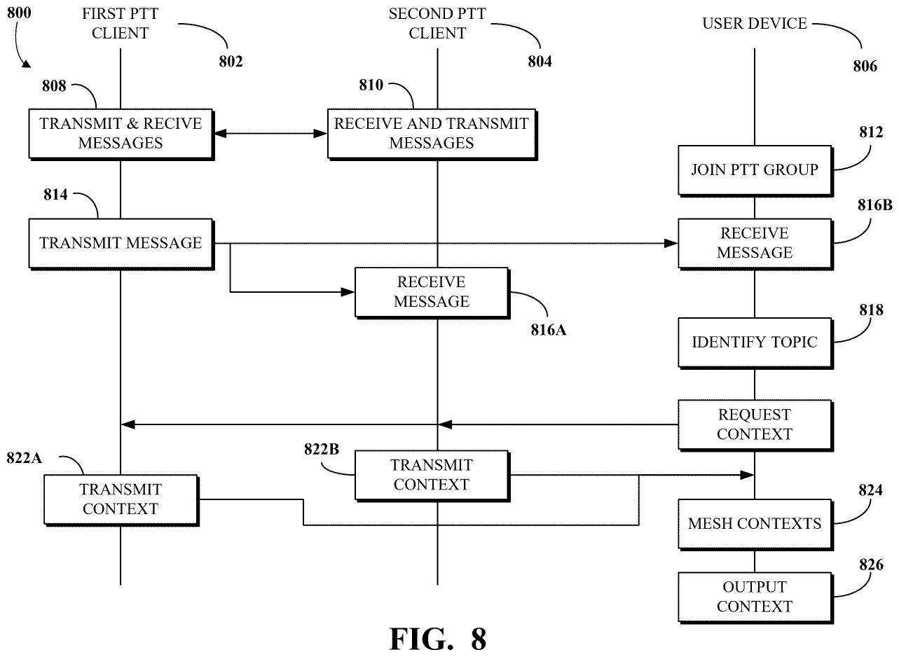

FIG. 9 illustrates user interfaces of a PTT client software for presenting a context at a PTT client. A user interface 900 of a PTT client 902 shows that the PTT client 902 has just joined a PTT channel 904 named “CHANNEL 1.” The PTT channel 904 may be facilitated by a PTT system, such as the PTT system 400 described with respect to FIG. 4. As such, the PTT channel 904 can be facilitated by a PTT server, such as the PTT server 552 of FIG. 5B; or may be facilitated by a P2P configuration.

As soon as the PTT client 902 joined the PTT channel 904, an audio message 906 arrived at and was output by the PTT client 902, such as via a microphone. After the audio message 906 was output, the PTT client software displays a section 908 enabling the user to obtain a context for the audio message 906. The section 908 can be a notification from the PTT channel that prior context is available for review.

The user can obtain the context by selecting one or more of context formats 910-914. The context format 910 enables the user to obtain a summary of previous audio messages that are contextually relevant to the audio message 906. The context format 912 enables the user to obtain the contextually relevant audio messages themselves. The context format 914 enables the user to obtain textual transcriptions of the contextually relevant audio messages. The PTT client 902 transmits a context request (which may be one or more context requests in a P2P configuration) in response to the user invoking (e.g., pressing) a user control 916.

A user interface 918 illustrates presenting the context at the PTT client 902. The user interface 918 displays the context information generated by the PTT system. Specifically, the user interface 918 includes a section 920 titled “SUMMARY,” which provides a brief summary of contextually relevant audio messages that are related to the audio message 906. This summary might include key points or highlights from the previous communications within the PTT channel 904. The user interface 918 also includes a section 922 labeled “LAST 5 MESSAGES.” This section displays the last five contextually relevant messages, showing both the sender (e.g., “BOB,” “JACK,” “CHARLIE”) and the corresponding contextually relevant messages.

In the case that the PTT client is not capable of displaying textual information, instead of text-based notification that prior context is available for review, the PTT client software may output an audible sound (e.g., two beeps) as the notification that prior context is available for review. Instead of the user control 916, the user may press a key combination (e.g., *#3) to play the cause the contextually relevant audio messages to be output. In such a configuration, the PTT client may include a buffer (e.g., a memory) for storing received audio messages while the contextually relevant audio messages are played back. After the contextually relevant audio messages are played back, any buffered audio messages are then played back. In an example, the buffered audio messages may be played back at a higher than normal speed (e.g., at 1.5× speed).

In some implementations, the PTT client software may enable the user to obtain a list of tags associated with a current session of the PTT channel. For example, when the user invokes a control 924, the PTT system may present to the user a list of the tags associated with the current session. In response to selecting one of the tags, the PTT system enables the user to obtain a context associated with the tag, such as described with respect to the section 908.

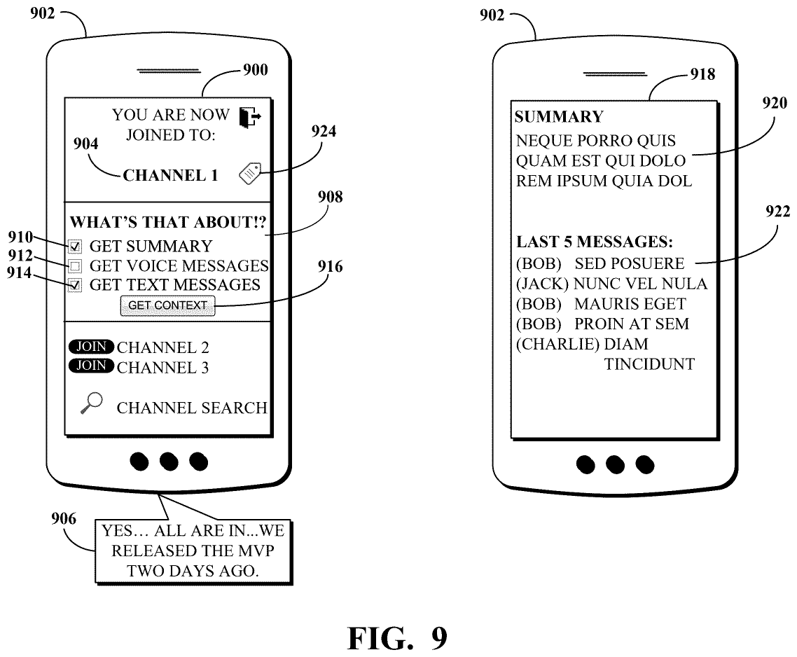

To further describe some implementations in greater detail, reference is next made to examples of techniques which may be performed by or using a system for providing context to a client device joining a PTT channel. FIG. 10 is a flowchart of an example of a technique 1000 for providing context in server-based implementations of a PTT system. The technique 1000 can be executed using computing devices, such as the systems, hardware, and software described with respect to FIGS. 1-9. The technique 1000 can be performed, for example, by executing a machine-readable program or other computer-executable instructions, such as routines, instructions, programs, or other code. The steps, or operations, of the technique 1000, or another technique, method, process, or algorithm described in connection with the implementations disclosed herein can be implemented directly in hardware, firmware, software executed by hardware, circuitry, or a combination thereof.

At 1002, a device (e.g., a PTT client) is joined to a PTT channel. The PTT channel is configured to facilitate real-time communication among multiple devices. At 1004, prior audio messages transmitted within the PTT channel before the device joined the PTT channel are identified. The prior audio messages are contextually relevant to an ongoing conversation within the PTT channel. The identification process may involve analyzing the prior audio messages based on a context retrieval option associated with the PTT channel, such as a time duration or a number of audio messages. In an example, the prior audio messages can be identified based on a context retrieval option associated with a user of the device. The ongoing conversation can be identified based on the most recent audio message transmitted in the PTT channel immediately after the device joins the PTT channel. That is, the prior messages can be identified based on the most recent audio message. Tags associated with the prior audio messages and the ongoing conversation are compared to identify the prior audio messages as being relevant.

At 1006, according to a context format, the identified prior audio messages are provided to the device. The context format of the prior audio messages can vary, including providing a summary of the prior audio messages or textual representations of the prior audio messages. In an example, the context format may be received from the device. In another example, the PTT server may determine the format based on the device (e.g., based on the device capabilities). For example, if the device does not include a display, then no textual representations are provided to the device. The context format may indicate whether the prior audio messages are delivered as a summary, as textual representations, or as a list of audio message. If a list of audio messages is to be sent to the device, then the PTT server may compress the audio messages prior to transmission; and the device decompresses the audio messages upon receipt.

In an example, a list of tags may be identified based on the audio messages transmitted during the session of the PTT channel and the list of tags is provided to the device. The user may then select one or more of the tags and request a context related thereto.

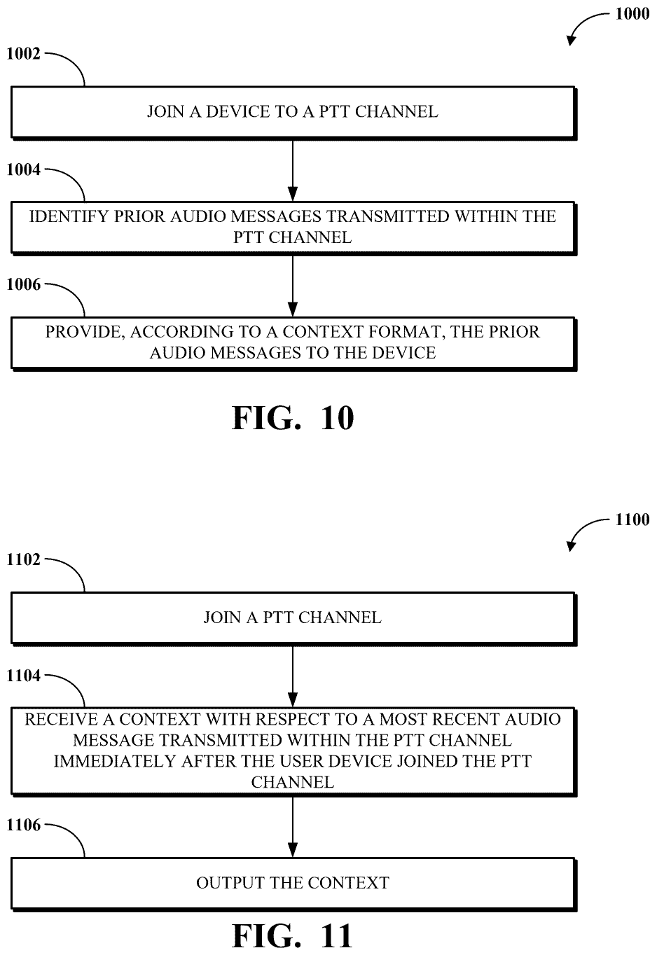

FIG. 11 is a flowchart of an example of a technique 1100 for receiving a context in server-based implementations of a PTT system. The technique 1100 can be executed using computing devices, such as the systems, hardware, and software described with respect to FIGS. 1-9. The technique 1100 can be performed, for example, by executing a machine-readable program or other computer-executable instructions, such as routines, instructions, programs, or other code. The steps, or operations, of the technique 1100, or another technique, method, process, or algorithm described in connection with the implementations disclosed herein can be implemented directly in hardware, firmware, software executed by hardware, circuitry, or a combination thereof. The technique 1100 can be executed by a user device that is part of a PTT system.

At 1102, the user device joins a PTT channel. The PTT channel facilitates real-time communication among multiple devices. At 1104, the user device receives, from a PTT server a context related to the most recent audio message transmitted in the PTT channel immediately after the user device joined the PTT channel. The context may include a summary of prior messages that are contextually relevant to the most recent audio message. Additionally, the context can be received according to a format selected by the user of the device. In some implementations, the context is received in a textual format and may be output by the device as text displayed on a display. Alternatively, the device may convert the textual context to speech using a text-to-speech engine and output the context audibly to the user.

The context can be in a format indicated by a context format. The context format can be specified by the user or determined based on the device's capabilities, such as whether it includes a display for textual output or only supports audio output. In an example, a request is transmitted to the PTT server indicating the context format for the context.

At 1106, the context received by the user device is output to the user. Outputting the context may include buffering incoming PTT audio messages while the context is being presented and then outputting the buffered PTT audio messages after the context has been fully delivered to the user. If a notification is received from the PTT server indicating that the context is available, the device may output an alert to the user, informing them of the availability of the context.

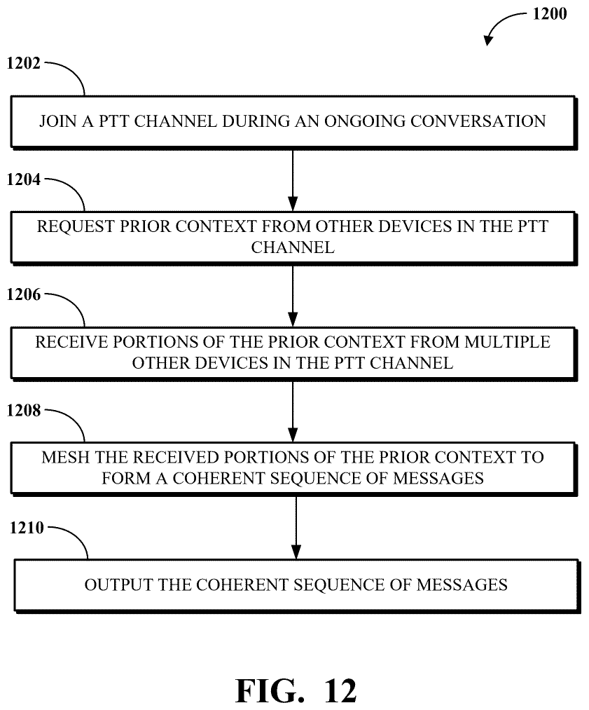

FIG. 12 is a flowchart of an example of a technique 1200 for providing context in P2P implementations of a PTT system. The technique 1200 can be executed using computing devices, such as the systems, hardware, and software described with respect to FIGS. 1-9. The technique 1200 can be performed, for example, by executing a machine-readable program or other computer-executable instructions, such as routines, instructions, programs, or other code. The steps, or operations, of the technique 1200, or another technique, method, process, or algorithm described in connection with the implementations disclosed herein can be implemented directly in hardware, firmware, software executed by hardware, circuitry, or a combination thereof.

At 1202, a device joins a PTT channel during an ongoing conversation. This action may initiate the process of retrieving prior context related to the ongoing conversation. The PTT channel is configured to facilitate real-time audio communication among multiple devices.

At 1204, the device requests prior context from other devices in the PTT channel. The prior context includes messages related to the ongoing conversation that were transmitted before the device joined the PTT channel. In an example, the device may identify tags associated with a first audio message received immediately after the device joined the PTT channel. The device may include these tags in the request. In another example, the other devices can identify the first audio message based on a time that the first audio message was transmitted and the time that the device joined the channel. In an example, the time that the device joined the PTT channel may be transmitted in the request by the device. In another example, each device may keep track of the times that other devices join the channel.

At 1206, the device receives portions of the prior context from the multiple other devices in the PTT channel. At 1208, the received portions of the prior context are meshed to form a coherent sequence of messages. This meshing process involves arranging the messages in chronological order based on their timestamps and removing duplicate messages. As such, the coherent sequence of messages is a chronologically sequenced and de-duplicated set of messages. The device may also store the coherent sequence of messages in local memory. This way, if another device requests the context, the device can transmit the coherent sequence of messages to the requesting device.

At 1210, the coherent sequence of messages is output at the device. In an example, the requests for the contexts may include a context format. In the case that the context format indicates a list a textual representations, then the output may involve converting the meshed prior context from text to speech using a text-to-speech engine and outputting it audibly to the user. In an example, new messages received during the outputting of the coherent sequence may be buffered and output after the coherent sequence of messages has been fully presented to the user. In another example, the context format may indicate that the audio messages themselves be received. As such, a list of the messages may be output. The device may enable the user to interact with the coherent sequence of messages, such as by replaying or skipping specific portions of the sequence. For example, via key combination of the device, the user may replay or skip audio messages. In another example, the list of audio messages may be displayed at a display of the device. User interface controls may be associated with each of the audio message enabling the user to play, pause, or skip audio message.

In some implementations, the technique 1200 may include receiving a request from another device in the PTT channel for the prior context and transmitting, in response to the request, the coherent sequence of messages to that device.

For simplicity of explanation, the techniques 1000, 1100, and 1200 of FIGS. 10, 11, and 12, respectively, are each depicted and described herein as a respective series of steps or operations. However, the steps or operations of the techniques 1000, 1100, and 1200 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Some implementations are described below as numbered examples (Example 1, 2, 3, etc.). These examples are provided as examples only and do not limit the other implementations disclosed herein.

Example 1: A method includes joining a device to a push-to-talk (PTT) channel; identifying prior audio messages transmitted within the PTT channel before the device joined the PTT channel and that are contextually relevant to an ongoing conversation within the PTT channel; and providing, according to a context format, the prior audio messages to the device.

Example 2: The method of Example 1, wherein identifying the prior audio messages includes identifying the prior audio messages based on a context retrieval option associated with the PTT channel.

Example 3: The method of Example 2, wherein the context retrieval option include at least one of a time duration or a number of audio messages.

Example 4: The method of Example 1, further including associating respective one or more tags with the prior audio messages; and identifying at least one tag for the ongoing conversation, wherein identifying the prior audio messages includes identifying the prior audio messages based on a comparison of the at least one tag and the one or more tags.

Example 5: The method of Example 1, wherein providing, according to the context format, the prior audio messages to the device includes providing a summary of the prior audio messages to the device.

Example 6: The method of Example 1, wherein providing, according to the context format, the prior audio messages to the device includes providing textual representations of the prior audio messages to the device.

Example 7: The method of Example 1, further including identifying a list of tags based on audio messages transmitted during a session of the PTT channel; and providing the list of tags to the device.

Example 8: A system that includes a memory subsystem and processing circuitry. The processing circuitry configured to execute instructions stored in the memory subsystem to: join a device to a push-to-talk (PTT) channel; identify prior audio messages transmitted within the PTT channel before the device joined the PTT channel and that are contextually relevant to an ongoing conversation within the PTT channel; and provide, according to a context format, the prior audio messages to the device.

Example 9: The system of Example 8, wherein to identify the prior audio messages includes to identify the prior audio messages based on a context retrieval option associated with a user of the device.

Example 10: The system of Example 8, wherein to identify the prior audio messages includes to identify the prior audio messages based on a time duration or a number of audio messages.

Example 11: The system of Example 8, wherein to identify the prior audio messages includes to identify the prior audio messages based on a most recent audio message transmitted in the PTT channel immediately after the device is joined to the PTT channel.

Example 12: The system of Example 8, wherein the context format indicates to provide a summary of the prior audio messages.

Example 13: The system of Example 8, wherein the context format indicates to provide textual representations of the prior audio messages to the device.

Example 14: The system of Example 8, wherein the processing circuitry is configured to execute instructions stored in the memory subsystem to provide, to the device, a list of tags.

Example 15: A non-transitory computer readable media storing instructions operable to cause processing circuitry to perform operations that include joining a device to a push-to-talk (PTT) channel; identifying prior audio messages transmitted within the PTT channel before the device joined the PTT channel and that are contextually relevant to an ongoing conversation within the PTT channel; and providing, according to a context format, the prior audio messages to the device.

Example 16: The non-transitory computer readable media of Example 15, wherein the prior audio messages are identified based on a context retrieval option associated with the PTT channel.

Example 17: The non-transitory computer readable media of Example 15, wherein the prior audio messages are identified based on a context retrieval option associated with a user of the device.

Example 18: The non-transitory computer readable media of Example 15, wherein providing, according to the context format, the prior audio messages to the device includes providing a summary of the prior audio messages to the device.

Example 19: The non-transitory computer readable media of Example 15, wherein providing, according to the context format, the prior audio messages to the device includes providing textual representations of the prior audio messages to the device.

Example 20: The non-transitory computer readable media of Example 15, wherein the prior audio messages are identified based on a most recent audio message transmitted in the PTT channel immediately after the device is joined to the PTT channel.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
joining a device to a push-to-talk (PTT) channel;
identifying prior audio messages transmitted within the PTT channel before the device joined the PTT channel and that are contextually relevant to an ongoing conversation within the PTT channel; and
providing, according to a context format, the prior audio messages to the device.

2. The method of claim 1, wherein identifying the prior audio messages comprises:
identifying the prior audio messages based on a context retrieval option associated with the PTT channel.

3. The method of claim 2, wherein the context retrieval option comprises at least one of a time duration or a number of audio messages.

4. The method of claim 1, further comprising:
associating respective one or more tags with the prior audio messages; and
identifying at least one tag for the ongoing conversation,
wherein identifying the prior audio messages comprises:
identifying the prior audio messages based on a comparison of the at least one tag and the one or more tags.

5. The method of claim 1, wherein providing, according to the context format, the prior audio messages to the device comprises:
providing a summary of the prior audio messages to the device.

6. The method of claim 1, wherein providing, according to the context format, the prior audio messages to the device comprises:
providing textual representations of the prior audio messages to the device.

7. The method of claim 1, further comprising:
identifying a list of tags based on audio messages transmitted during a session of the PTT channel; and
providing the list of tags to the device.

8. A system, comprising:
a memory subsystem; and
processing circuitry, the processing circuitry configured to execute instructions stored in the memory subsystem to:
join a device to a push-to-talk (PTT) channel;
identify prior audio messages transmitted within the PTT channel before the device joined the PTT channel and that are contextually relevant to an ongoing conversation within the PTT channel; and
provide, according to a context format, the prior audio messages to the device.

9. The system of claim 8, wherein to identify the prior audio messages comprises to:
identify the prior audio messages based on a context retrieval option associated with a user of the device.

10. The system of claim 8, wherein to identify the prior audio messages comprises to:
identify the prior audio messages based on a time duration or a number of audio messages.

11. The system of claim 8, wherein to identify the prior audio messages comprises to:
identify the prior audio messages based on a most recent audio message transmitted in the PPT channel immediately after the device is joined to the PTT channel.

12. The system of claim 8, wherein the context format indicates to provide a summary of the prior audio messages.

13. The system of claim 8, wherein the context format indicates to provide textual representations of the prior audio messages to the device.

14. The system of claim 8, wherein the processing circuitry is configured to execute instructions stored in the memory subsystem to:
provide, to the device, a list of tags.

15. Non-transitory computer readable media storing instructions operable to cause processing circuitry to perform operations comprising:
joining a device to a push-to-talk (PTT) channel;
identifying prior audio messages transmitted within the PTT channel before the device joined the PTT channel and that are contextually relevant to an ongoing conversation within the PTT channel; and
providing, according to a context format, the prior audio messages to the device.

16. The non-transitory computer readable media of claim 15, wherein the prior audio messages is identified based on a context retrieval option associated with the PTT channel.

17. The non-transitory computer readable media of claim 15, wherein the prior audio messages is identified based on a context retrieval option associated with a user of the device.

18. The non-transitory computer readable media of claim 15, wherein providing, according to the context format, the prior audio messages to the device comprises:
providing a summary of the prior audio messages to the device.

19. The non-transitory computer readable media of claim 15, wherein providing, according to the context format, the prior audio messages to the device comprises:
providing textual representations of the prior audio messages to the device.

20. The non-transitory computer readable media of claim 15, wherein the prior audio messages are identified based on a most recent audio message transmitted in the PPT channel immediately after the device is joined to the PTT channel.
